(19) United States
(12) Patent Application Publication
(10) Pub. No.: US 2004/0225577 A1
(43) Pub. Date: Nov. 11, 2004

(54) System and method for measuring rating reliability through rater prescience

(76) Inventor: Gary Robinson, Bangor, ME (US)

Correspondence Address: ELMAN TECHNOLOGY LAW, P.C., P. O. BOX 209, SWARTHMORE, PA, 19081-0209, US

(21) Appl. No.: 10/837,354

(22) Filed: Apr. 30, 2003

Related U.S. Application Data
(63) Continuation of application No. PCT/US02/33512, filed on Oct. 18, 2002.
(60) Provisional application No. 60/345,548, filed on Oct. 18, 2001.

(51) Int. Cl. G06F 17/60

(52) U.S. Cl. 705/26

(57) ABSTRACT

A plurality of users are able to review items as raters and provide ratings for the reviewed items. In aggregating the rating values to provide a resolved rating value for the item, the prescience of the raters is evaluated. By establishing levels of reliability of the raters, it is possible to improve the relevance of the resolved rating values and to reward those providing highly reliable ratings.

### CROSS REFERENCE TO RELATED APPLICATIONS

This application is a continuation of International Patent Application PCT/US02/33512, international filing date in the United States Receiving Office, Oct. 18, 2002, which claimed priority from U.S. Provisional Patent Application 60/345,548, filed in the United States Patent and Trademark Office on Oct. 18, 2001, and claims the benefit of priority from both of the aforementioned applications. The instant application filed herewith incorporates by reference the entire contents of both of the aforementioned applications and the contents of a substitute specification, claims, drawings, and abstract, filed as an Article 34 Amendment to PCT/US02/33512, submitted on Apr. 3, 2003.

### BACKGROUND OF THE INVENTION

1. Field of the Invention

This invention relates to rating items in a networked computer system.

2. Description of Related Art

A networked computer system typically includes one or more servers, and a plurality of user computers connected to the servers through a network such as the Internet. In many instances, interaction is performed by the users. It is often desired to provide the users with evaluations of items with which the users are interacting, either because the value of the item is not immediately apparent to the user or there are a large number of items to select. Typically such items can be messages and other written work, music, or items for sale. Often the user will review the item and further interact with the item, and a rating is useful so that the user can select which item to interact with.

The domain of this invention is online communities where individual opinions are important. Often such opinions are expressed in explicit ratings, but sometimes ratings collected implicitly (for instance, through considering the act of buying an item to be the equivalent of rating it highly).

The purpose of this invention is to create an optimal situation for a) determining what members of a community are the most reliable raters, and b) to enable substantial rewards to be given to the most reliable raters. These two concepts are linked. Reliable ratings are necessary to determine which raters should be rewarded. The rewards can provide motivation to generate ratings that are needed to determine which items are good and which are not.

One system, used for rating posted messages, is described in U.S. Pat. No. 6,275,811 by Michael Ginn, System and Method for Facilitating Interactive Electronic Communication Through Acknowledgement of Positive Contributive.

While Ginn teaches a method to calculate the overall value of a user's messages, his methodology is not optimized for situations where a fine measure of degrees of value of each user's contributions is required, or where users are motivated to “cheat” by, for example, copying other users' ratings.

For example Ginn teaches that a variation of his technique is to “award points to people whose predictions anticipate the evaluations of others; for example, someone who evaluates a message highly which later becomes highly rated in a discussion group.” However, it is easily seen that it is not very useful to reward people whose ratings (“predictions”) agree with later ratings if they also agree with earlier ratings, because that would mean rewarding people who wait until the general community opinion is apparent and then simply copy that clear community opinion.

This is a significant problem because if a system gives substantive rewards, people will be motivated to find ways to earn those rewards with little or no effort, and under Ginn's approach they can do so. This means that truly valuable awards are not advisable under Ginn's system, whether the rewards are monetary or related to reputation. The present invention solves that problem.

Additionally, the method Ginn teaches for “validating” a user's rating is essentially to examine all the ratings for that user and determine whether they are generally valid or not, and then to grant a validity level for a new rating based on that history. Points are awarded based on that historically-based validity, rather than on the validity each rating earns “by its own merit.” A disadvantage of that approach is that a user might issue a number of ratings when starting to use a service that for one reason or another are considered invalid; then if he subsequently starts entering valid ratings, he will not get any credit for them until enough such ratings are entered that his overall validity classification changes. This could be discouraging for new users. The present invention solves that problem. A related problem is that a new user may simply not have issued enough ratings yet for it to be determined whether his opinion anticipates community opinion; again, under Ginn's technique he will get little or no credit for such ratings, and so does not receive positive feedback to motivate him to contribute further. Again, the present invention resolves that problem. In general, the approaches are different in that the present invention calculates the overall reliability of each rating and derives the reliability of the rater from that data; whereas Ginn calculates the overall reliability of each user and generates a “validity” level for each new rating based on that; all ratings generated by a particular user based on the methods taught by Ginn have the same value.

### SUMMARY OF THE INVENTION

The present invention involves conformance to a set of rules which promote optimal analysis of ratings, and teaches specific exemplary techniques for achieving conformance.

The Oxford English Dictionary (2nd. ed., 1994 version) defines “prescience” as “Knowledge of events before they happen; foreknowledge. as a human faculty or quality: Foresight.” In general a rater is considered to be more reliable if he shows a superior tendency toward prescience with regard to other people's ratings and enters his ratings early enough that is is unlikely that he is simply copying other raters.

This reliability, in preferred embodiments, is determined by examining each of a user's ratings over time and independently determining it's value. The user's value is based on a summary of the value for his ratings.

### BRIEF DESCRIPTION OF THE DRAWINGS

FIG. 1 represents the network configuration of a typical embodiment.

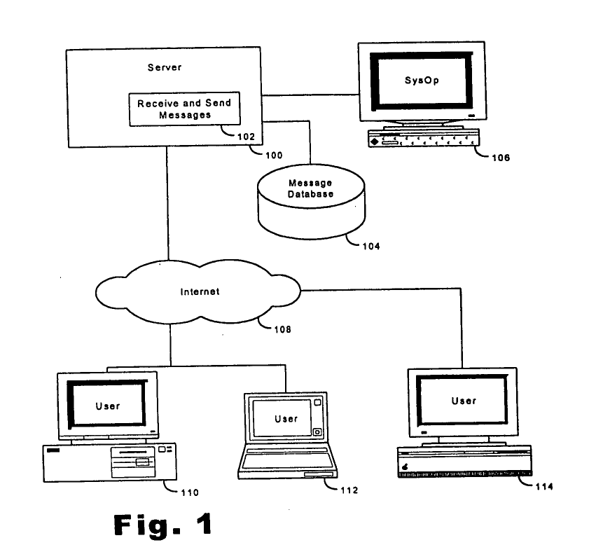

FIG. 2 is a flow chart depicting user interactions with the system and the processes that handle them.

FIG. 3 is a flow chart of the method for displaying a list of items to the user.

FIG. 4 is a flow chart of the method for processing a rating, leaving it marked as “dirty”

FIG. 5 is a flow chart of the method for processing dirty ratings.

FIG. 6 is a flow chart of the method for computing the rating ability of a user.

FIG. 7 is a flow chart of the method for displaying a list of users to the user.

FIG. 8 is a flow chart of the method for computing a user's overall rating ability.

### DESCRIPTION OF THE SPECIFIC EMBODIMENTS

Overview

The present invention involves conformance to a set of rules which promote optimal analysis of ratings, and teaches specific exemplary techniques for achieving conformance.

The Oxford English Dictionary (2nd. ed., 1994 version) defines “prescience” as “Knowledge of events before they happen; foreknowledge. as a human faculty or quality: Foresight.” In general a rater is considered to be more reliable if he shows a superior tendency toward prescience with regard to other people's ratings and enters his ratings early enough that it is unlikely that he is simply copying other raters.

This reliability, in preferred embodiments, is determined by examining each of a user's ratings over time and independently determining it's value. The user's value is based on a summary of the value for his ratings.

According to the present invention, a system for processing ratings in a network environment includes the following rules:

1. A rater's reliability should generally correspond to his ability to match the eventual population consensus for each item, with certain exceptions, some of which are noted below. That is if he is unusually good at matching population opinion his reliability should be high; if he is average it should be average; and if he is unusually poor it should be low.

2. The “Correct Surprise” rule: If a rating agrees with the population's opinion about an item, and also disagrees with a reasonable guesstimate of the eventual opinion of an item based only on data available to the rater at the time the rating is generated, the rater's reliability should increase relative to other raters. In this case, a reasonable estimation made by the user would have resulted in a different result, but the user accurately predicted a change in the eventual aggregate consensus.

3. The “No Penalty” rule: Notwithstanding the foregoing, it is useful, particularly in embodiments which include substantial rewards for reliable raters, that if a rating tends to agree with earlier ratings as well as with later ones, then that rating should have little or no negative impact on the rater's overall reliability. The reason for this is that the more ratings are collected for each item, the more certain the system can be about the community's overall opinion, so from that point of view, the more ratings the better. But in such cases, later raters will not have the opportunity to disagree with earlier ones. Without the No Penalty rule, the Correct Surprise rule causes late ratings to make raters seem worse (in calculated reliability) than raters without such ratings, discouraging those important later ratings from being generated. In contrast, under the No Penalty rule, such ratings will not hurt calculated reliabilities. Rather, it would be more as if those ratings never occurred at all from the viewpoint of the reliability calculations.

4. If A has entered more ratings than B, then A's reliability should tend to be less than B's if other factors indicate a similar less-than-average reliability, and greater than B's if other factors indicating a similar greater-than-average reliability.

5. If rater A tends to enter his ratings when there are fewer earlier ratings for the relevant items than B does, that should tend to result in more reliability for A, at least for items that in the long run are felt by the community to be of particular value. This motivates people to rate earlier rather than later, and also allows us to pick out those raters who are consistent with long-term community opinion and who are unlikely to have earned that status by copying earlier votes (because there were fewer of them, and therefore there was less certainty about community opinion).

6. If a rater tends to disagree with later ratings, then the effect of his agreement or disagreement with earlier ratings should be less than if he tends to agree with later ratings. The reason for this is that if a user tends to disagree with later ratings, he is acting contrarily to the actual value of the item (as perceived by the community), and can only consistently do so if he actually examines the item at hand and rates it the wrong way. If someone is doing that, that fact is more important then his agreement or disagreement with earlier ratings, because that agreement or disagreement is mostly useful for detecting whether he is making the effort to evaluate the item at all. Whereas, if he consistently disagrees with community opinion, he is probably making the effort to evaluate the items but is rating them in a way that is contrary to community interest. So in such a case we have reason to believe he is considering the items, and it is therefore less important to using earlier ratings to evaluate whether or not he is doing so.

Notes: that the ratings may be actively or passively collected. When the concepts of “prescience” and “agreement with the community” are considered, in various embodiments these may involve prescience or agreement with respect to a particular subset of a larger community rather than with the community as a whole, which may be created by clustering technologies, or grouping people according to the category of items they look at most frequently, or by enabling users to explicitly join various subcommunities, etc. The concept of “earlier” and “later” ratings is equivalent to the concept of “ratings knowable by the user at the time he entered his rating” and “ratings not knowable by the user at that time”; the invention encompasses embodiments based on either of these concepts, although it focuses on time for simplicity of example.

Note that when doing calculations relative to “later” ratings there may not yet be any later ratings. In some embodiments, this is handled by including earlier ratings with the later ratings in one set so that there will still be a population opinion to consider and for algorithmic simplicity. However, in such cases the basic idea is still to measure prescience with respect to later ratings, and so it is considered to be a good thing when there are enough later ratings that the earlier ones have a minimal impact on the calculations; alternatively in some embodiments earlier ratings are removed completely from the “later” set when it is considered that there are enough later ratings to be reliably indicative of a real community opinion.

Ginn's methodology could be amended to conform to more of these rules than is taught by Ginn. In particular, a Ginn-based system could be created that implements the Correct Suprise rule by calculating the degree to which ratings that agree with the population of raters of the rated items tend to disagree with reasonable guesstimates (estimations) of the ratings of those items based on earlier data. Ginn-based systems which do that, using calculations modeled after examples that will be given below or using other calculations, fall within the scope of the present invention.

However the present invention also teaches a superior approach to doing the necessary calculations which is independent of the Ginn approach. Under the present invention, the “goodness” of each rating is calculated independently of that of other ratings for the user. These goodnesses are then combined to partially or wholly comprise the calculated reliability of the rater. In contrast, under Ginn's approach which involves seeing whether “the ratings had a positive correlation with the ratings from others in their group,” no individual goodness is ever calculated for individual ratings. Rather the user's category is calculated based on all his ratings, and that category is used to validate new ratings.

So the two approaches are the reverse of each other. In the present case, a value is calculated for each of the current user's ratings independent of his other ratings, and these values are used as the basis for the user's calculated reliability; and in the Ginn approach, the user's category is calculated based on his body of ratings, and this category is used to validate each individual new rating. Hereafter the two approaches will be called “user-first” and “rating-first” to distinguish Ginn (and Ginn-like) approaches vs. ours.

User Interactions

We now describe some typical embodiments through drawings.

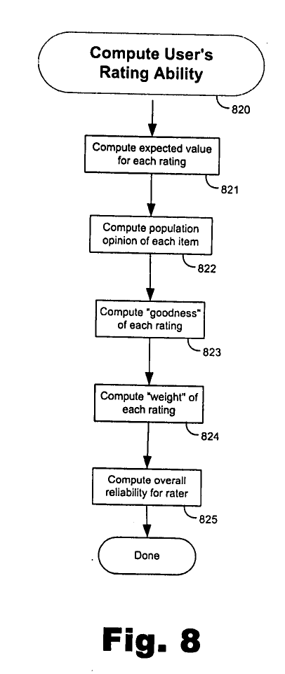

FIG. 8 is a flow chart of the method for computing a user's overall rating ability. After the rating procedure is started 820, and a computation 821 is made of an expected value is made for each rating. The “goodness” or each rating is calculated 823 and in exemplary embodiments a “weight” of each rating is also calculated 824. Then these values for a plurality of the user's ratings are combined 825 to produce an overall evaluation of the reliability of the rater in step.

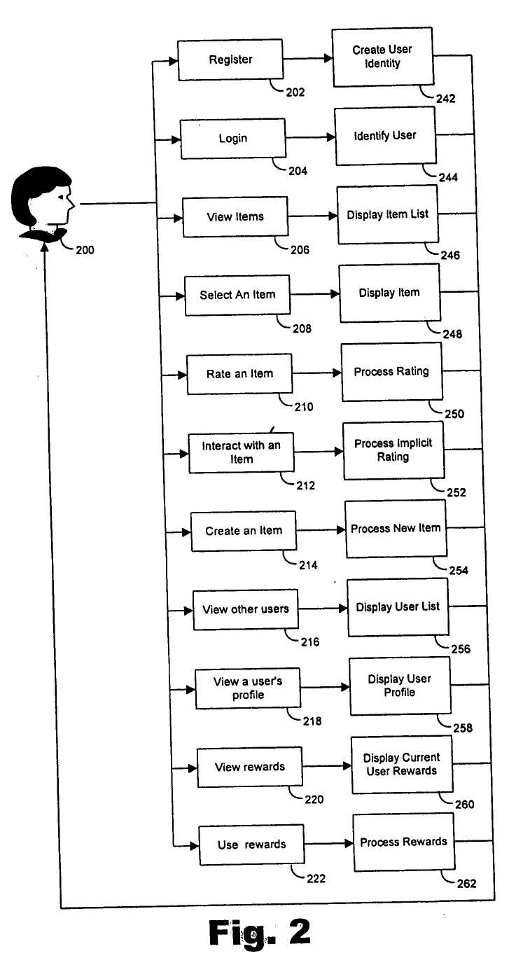

FIG. 2 shows a typical user 200, the interactions that he or she might have with the system, and the processes that handle those interactions.

The user may select a feature to register 202 himself or herself as a known user of the system, causing the system to create a new user identify 242. Such registration may be required before the user can access other features.

The user may login 204 (either explicitly or implicitly) so that the system can recognize him or her 244 as a known user of the system. Again, login may be required before the user can access other features.

The user may ask to view items 206 which will result in the system displaying a list of items 246, in one or more formats convenient to the user. From that list or from a search function, the user may select an item 208 causing the system to show the details about that item 248. The user may then express an opinion about the item explicitly by rating it 210 causing the system to process that rating 250 or the user may interact with the item 212 by scrolling through it, clicking on items within it, keeping it on display for a certain period of time or any other action that may be inferred to produce an implicit rating of the item, causing the system to process that implicit rating 252.

The user may ask to create an item 214, causing the system to process the information supplied 254. This new item may then be made available for users to view 206, select 208, rate 210, or interact with 212.

The user may select a feature to view other users 216, causing the system to display a list of users 256 in one or more formats. From that list or from a search function the user may then request to see the profile for a particular user 218, causing the system to show the details for that user 258.

The user may also view his or her own rewards 220 that are available, causing the system to display the details of that user's awards 260. In cases where the rewards have some use, as in a point system where the points are redeemable, the user can ask to use some or all of the rewards 222 and the system will then process that request 262.

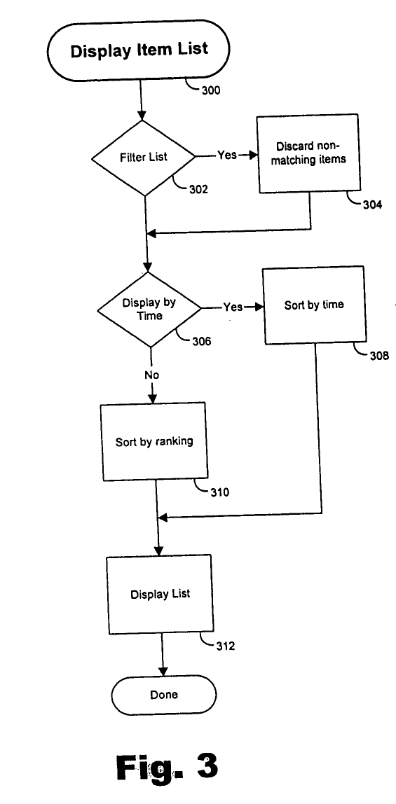

The steps involved in displaying a list of items to the user (FIG. 2, step 246) are shown in FIG. 3. Input from the user determines if the list is to be filtered 302 before it is displayed. In step 304, any items that do not match the criteria for filtering are discarded before the list is displayed. The criteria might include the type of item to be displayed (for example, in a music system the user might wish to see only items that are labeled as “rock” music), the person who created the item, the time at which the item was created, etc.

Next, in step 306, it is determined what sort order the user is requesting. In step 308 the items are sorted by time, while in step 310 the items are sorted by the ranking order defined later in this description. Other orders are possible, such as alphabetic ordering, but the key point is that ordering by computed ranking is one of the choices. Finally, at step 312 the prepared list is displayed for the user.

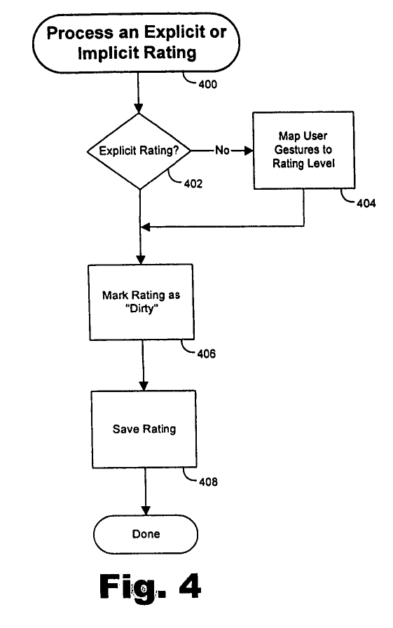

The steps involved in processing a rating supplied by user, FIG. 2, steps 250 and 252, are shown in FIG. 4. The first step 402 is to determine if the rating is an explicit rating or an implicit rating. Explicit ratings are set by the user, using a feature such as a set of radio buttons labeled “poor” to “excellent”. Implicit ratings are inferred from user gestures, such as scrolling the page that displays the item information, spending time on the item page before doing another action, or clicking on links in the item page. If the rating is implicit, then step 404 determines what rating level is to be used to represent the implicit rating. The selection of rating levels can be based on testing, theory or guesswork. In step 406, the ratings is marked “dirty” indicating that additional processing is needed, and then in step 408, the new ratings are saved for later retrieval.

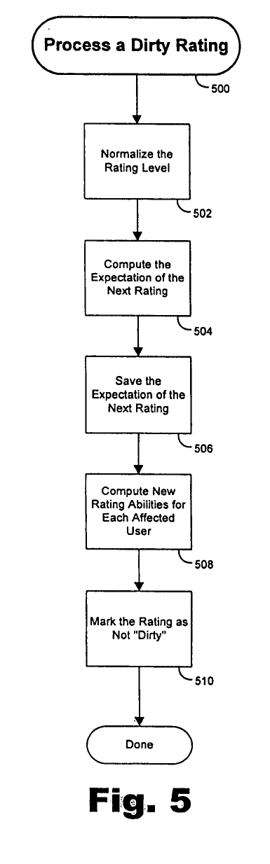

FIG. 5 shows the steps in processing dirty ratings. These steps can be taken at the point where the rating is marked dirty or later, in a background process. First the new rating's rating level is normalized in step 502. Then the expectation of the next rating is computed in Step 504—the expectation is the numerical value that the next rating is most likely to have, based on prior experience. In step 506, the new expectation is saved so that it can be used in later computations. Since users' rating abilities are based in part on the goodness of each expectation, the rating abilities of the users affected by this new rating must be recomputed 508. Finally, the rating is marked as not “dirty” so that the system knows that it does not need to be processed again.

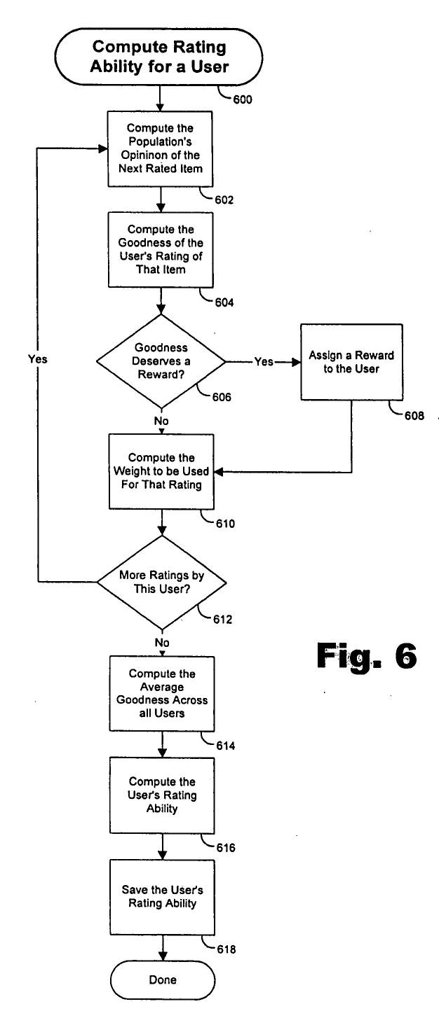

FIG. 6 shows the steps in computing the rating ability for a user. Each item that the user has rated needs to be processed as part of this computation. First the population's overall opinion of an item is computed 602 as described in this patent. Then, the “goodness” of the user's rating for that item is computed 604. If that goodness level is sufficient, as determined in step 606, then a reward is assigned to the user in step 608. Next, the weight to be used for that rating is computed in step 610. These steps (602, 604, 606, 608, 610) are repeated for each additional item that the user has rated. Next, the average goodness across the users is computed in step 614. The results of all of these computations are then combined as described in this patent to produce the user's rating ability in step 616, and this value is then saved for future use in step 618.

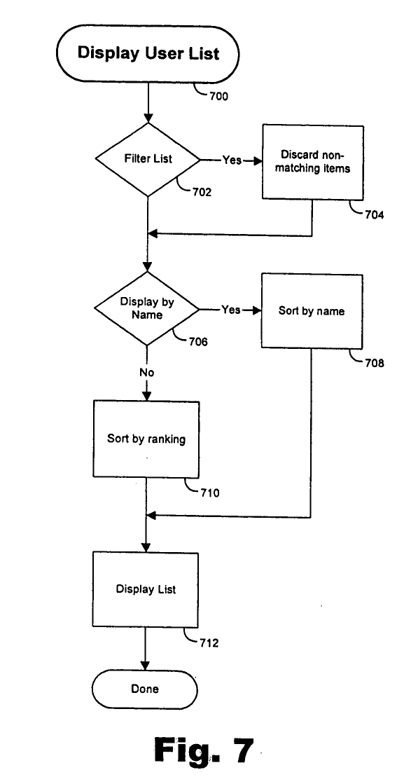

The steps involved in displaying a list of users (FIG. 2, step 256) are shown in FIG. 7.

Input from the user determines if the list is to be filtered 702 before it is displayed. In step 704, the profiles of any users who do not match the criteria for filtering are discarded before the list is displayed. The criteria might include the location of the user, a minimum ranking, etc.

Next, in step 706, it is determined what sort order the user is requesting. In step 708 the items are sorted by name, while in step 710 the items are sorted by the ranking order which is saved in step 618 on FIG. 6. Other orders are possible, such as alphabetic ordering, but the key point is that ordering by computed ranking is one of the choices. Finally, at step 712 the prepared list is displayed for the user.

Some exemplary calculational approaches for embodying the invention:

Approach 1—user-first.

Modify step 520 in the Ginn patent such that Ginn's “category (1)” users are those who rated messages and the ratings had a significantly positive correlation with the ratings from later raters of the rated items while having a negative or near-zero correlation with earlier raters of the rated items.

Approach 2—user-first.

Modify step 520 in Ginn such that users whose ratings tended to correlate both with earlier and later ratings for the same items are in a new category. In embodiments that award points, this category would be associated with a smaller number of points than category (1) users would command.

Approach 3—user-first.

Instead of using discrete rating levels such as Ginn uses, a softer methods may be used which carry more nuanced meanings.

For example, let e′ be 1-(the Pearson product moment coefficient of correlation with the earlier ratings for the rated items), and a′ be 1-(the Pearson product moment coefficient of correlation with all ratings for those items (including the earlier ratings)). Let y be the user's reliability (which would be used as part or all of the calculation of validity in Ginn).

Furthermore, let e be a transformation of e′ made by conducting normalized ranking of e′ to the (0,1) interval (see the section on normalized ranking elsewhere in this specification). Do the analogous calculation on a′ to generate a. Let sqrt( ) be the square root function.

Then

y=(1−a′+sqrt((1−a′)*e′)/2

This calculation for validity of a user's ratings is consistent with Rules 1 and 2. y is a number between 0 and 1, such that people with average abilities for the e and a components get a reliability of 0.5 (i.e., an average reliability).

A problem with the above user-first approaches is that they only encompass the first two rules. In particular, to get the full benefit of the No Penalty rule, each rating has to be processed individually, which user-first approaches don't do.

Introduction to Rating-First Embodiments

In rating-first embodiments, several tasks need to be carried out to compute a user's rating ability. They are depicted in FIG. 8.

In step 821, for each rating, a “guesstimate” about what a user could be expected to expect the value of the item based on earlier (visible) ratings needs to be calculated. If there are no earlier ratings, then such a guesstimate or estimation should still be calculated.

In step 822 a population opinion needs to be calculated based on whatever ratings exist (in some variations these are only later ratings but preferred embodiments use all ratings other than those of the rater whose abilities we are trying to measure).

Then using these calculations, the “goodness” or each rating is calculated in step 823 and in preferred embodiments a “weight” of each rating is also calculated in step 824. Then these values for a plurality of the user's ratings are combined to produce an overall evaluation of the reliability of the rater in step 825.

Approach 4—rating-first

For each rating we do the following. First the rating is normalized to the (0,1) interval.

We refer to U.S. Pat. No. 5,884,282 to Gary Robinson to see how to do this. For each rating level, we use the corresponding MTR value as shown in TABLE IV (in column 23) of that patent (of course TABLE IV would need to be adjusted for the number of ratings levels in a given embodiment).

Now we compute an expectation of the next rating, based on earlier ratings. That is, based on the background knowledge (the overall distribution of ratings in the population in general) combined with whatever earlier ratings may be available for the item in question, we calculate what we should expect the next rating to be consistent with that data. This is a way of representing the population opinion based only on earlier ratings.

For example, in one approach we average together the earlier ratings for the item in question with some number (which may be fractional) of “pretend” normalized ratings which are based on the population at large. For instance, the population average rating might be 0.5. Further, let t be the average of the n earlier ratings for the item, and let w be the weight of the background knowledge, that is, how important the population average should be compared to the average of the earlier ratings. Then the expectation of the earlier ratings is ((w*0.5)+(n*t))/(w+n).

Using the above technique with fairly low w (say, 1), we produce a rating expectation that is close or the same as a reasonable person might choose as his “best guesstimate” about the probable rating of a song based only on earlier ratings for that item and other items. The “best guesstimate” would be an attempt by the user to make a reasonable estimation of the eventual opinion of an item based only on data available to the rater at the time the rating is generated.

Thus, it is a rating very close to one that a malicious user might choose if he were trying to get credit for being an accurate rater without actually taking the time to examine the rated item and determine its worth for himself.

Next we compute the population's opinion (or population consensus, as it is also referred to herein). This is based on later ratings, but to handle the case of having too few later ratings to reliably determine the community opinion, in this example we also use earlier ratings and the “pretend” ratings as we do when process the guesstimate for earlier ratings. That is, to calculate an expectation of the next rating for the item, average all ratings for the items other than the current user's. As data is collected over time, it is expected that the later ratings will overwhelm the earlier ones, so if the earlier ones happen to be unrepresentative of community opinion that will not be a problem in the end.

In the following paragraphs, for readability, the word “ratings” will be used to refer to “normalized ratings”.

Let m be the expectation of the next rating, based on earlier ratings, for the item in question. Let q be the expectation of the next rating for the item.

Let x be the current user's normalized rating for the item in question.

Then let the difference beween the current rating and earlier ratings for the rated item be e=absval(x−m).

and let the difference beween the current rating and all ratings for the rated item be a=absval(x−q).

Let g=((1−a)+sqrt((1−a)*e))/2. This is the “goodness” of the current rating.

Let w=e+a−sqrt(e*a). This is the “weight” of the current rating.

Let G be the population average goodness (that is, the average of all goodness values for all ratings for all users).

Let s be the relative strength we want to give the background information derived from the entire population of goodness values relative to the goodness values we have calculated for the current user's ratings.

Let g1, g2 . . . , gn represent the goodness g of the nth rating. Similarly, let w1, w2 . . ., wn be the corresponding weights.

Then let the current user's rating ability, R, be defined as:

R=((s*G)+((g1*w1)+(g2*w2)+ . . . +(gn*wn)))/(s+w1+w2+ . . . +wn).

This formulation for R complies with all of the 5 rules. In particular, the No Penalty rule is embodied in the weights w. When the user agrees with guesstimated community opinion based on earlier ratings, and that is the same as the overall opinion, e and a are both 0, so w is 0, and the rating has no impact. In many embodiments the user's ratings can only take on certain discrete values, whereas they are being compared to average values based in part on a number of such discrete values, so e and a will rarely be exactly 0, but they will nevertheless be small when the user is in general agreement with the earlier evidence and with the overall opinion, so w will be small, and the values will thus be largely, if not completely, ignored.

The way rule 5 is invoked by this approach is a bit subtle. When there are no or very few earlier ratings, the background information dominates our guesstimate of community opinion based on earlier ratings—that is they are the same as, or close to, the population average. So, if an item is in fact worthy but has no or very few earlier ratings, and the current rater rates the item consistently with its value, he will necessarily be rating it far away from the community average. This will cause e to be large, and when e is large, g and w are likelier to be large, which in turn tends to cause the rater to have more measured reliability. This only happens with respect to items that are in fact worthy, but those are the ones of the most value to the community, so in many applications that is acceptable.

Note that in a variant to this approach we set w to be always 1 (that is, not carry out the calculations for the weight). While this limits the usefulness of the algorithm, R would still be consistent with all rules except the No Penalty rule, and thus falls within the scope of the invention. In general even less capable embodiments are within the scope as long as they conform with rules 1 and 2.

Approach 5—rating-first

In this approach we modify Approach 4 by calculating weights u of value 1 or 0 based on w:

Let u=0 if w<0.25; otherwise u=1.

The advantages to this approach are that it makes sure that “copycat” raters get no credit for copycat ratings; and it gives full credit to ratings that don't appear to be copycat ratings. In such embodiments, u simply replaces w in the calculation for R.

The question of whether to use u or w depends on a number of factors, most particularly the amount of reward a user gets for entering ratings. If in a particular application the reward very little, it may be a good idea to use w since he will still usually get some reward for each rating—hopefully an amount set so that there isn't enough value to motivate cheating, but there's enough that there is satisfaction in going to the trouble of rating something. In applications where the amount of reward is high, the more draconian u is more appropriate.

Approach 6—rating-first

In this approach we modify Approach 5 to put less weight on the earlier ratings and “pretend” ratings added to adjust the expectation as time goes on in calculating q. We simply multiply the relevant values by a “decay factor” that grows smaller with time, for instance, by starting at 1 and becoming half as great every month as it was the month before.

The reason for this is that we don't want to give a user too much credit for being a reliable rater prematurely—that is, when there are only a small handful of later ratings. On the other hand, if time goes on and the number of later ratings is not growing into a meaningful one—perhaps because only a few people are interested in the type of item being rated (that is, for example, a song in a very obscure genre that few people listen to), then it seems unfair to keep someone who was in fact prescient with respect to the actual raters of the song from getting credit for it.

Note that since we are multiplying all the non-later numbers by the decay factor, both in the numerator and denominator in the calculation for q, if there are no later ratings at all the result of the calculation does not change as the decay factor becomes smaller.

Approach 7—rating-first Some embodiments use a Bayesian approach based on a Dirichlet prior. Heckerman (http://citeseer.nj.nec.com/heckerman96tutorial.html) describes using such a prior in the case of a multinomial random variable. This allows us to use the following technique for producing a guesstimate of population opinion based on the earlier ratings.

Assume there are 7 rating levels, with values v1, v2, . . . v7.

Let q1 be the proportion of ratings across all items and users that are at the first rating level; let q2 be the corresponding number for the second rating level; etc. up to the seventh. The kth proportion will be referred to as qk.

Let s be the desired strength of this background information on the guesstimate for the earlier ratings.

Let c1, c2, . . . c7 represent the count of earlier ratings with respect to the current rating in each of the 7 rating levels. The kth count will be ck. Let C be the total of these counts.

Then the estimated probability that the next rating would fall into the kth level based on the earlier ratings is:

pk=((s*qk)+ck)/(s+C).

Then the posterior mean of these values is

m=(p1*v1)+(p2*v2)+ . . . +(p7*v7).

m is our guesstimate of the rating that would be entered by a malicious user who is trying to give “accurate” ratings without personally evaluating the item in question.

Now, using the same calculations but based on all ratings for the item other than the ones for the current user, we can calculate q, the posterior mean of the population opinion about the item.

Then we calculate R from e, a, the current rater's rating x, and the population average goodness G as in Approach 4.

Other variations further modify this Approach 7 as Approach 4 is modified in Approaches 5 and/or 6.

Approach 8—rating-first

Approach 4 and the approaches based on it calculate a guesstimate of the community opinion based on earlier and later data and then compare the current rater's rating to that.

A different approach is to calculate probabilities for the user's rating based on earlier and later ratings. That is, knowing what we know at various times, how likely was it that the rating the user gave would have been the next rating?

We again use a Bayesian approach with a Dirichlet prior, and calculate the pk relative to each level k as in Approach 7. But we don't compute a posterior mean. Instead, assume the user's rating was x, where x is one of the k rating levels. Then we use:

e′=1−px (where px is calculated with respect to earlier ratings for the item)

and

a′=1−px (where px is calculated with respect to all ratings for the item other than the current rater's).

These raw values for e′ and a′ can never approach 0 very closely and may in fact never even reach 0.5 so the calculation given in Approach 4 for generating R from e′ and a′ won't directly work in this case.

However, we handle this now by performing normalized ranking (explained below in this specfication) to produce e and a from e′ and a′, respectively.

Finally, we use the Approach 4 calculations to generate R for the user from the e and a values for each of his ratings.

Approach 9—rating-first

This is like Approach 8, modified to address a problem with that approach. Suppose we have 7 rating levels, and exactly two ratings other than the current user's for the current item, one of which is a 5 and the other is a 7, and further suppose that the current user rated the item a 6 and that his was the first rating.

It is intuitively clear that the current user agreed very well with the population. (Particularly since research conducted at the Firefly company before it was purchased by Microsoft found that when people were asked to rate the same item two times with a week in between, the were fairly likely to vary by one rating level.)

However, e and a generated under Approach 8 will be exactly identical to the case where the two other people both rated the current item a 1. So Approach 8 is not likely to be very effective except where there is an expectation of a very high number of ratings (it is unlikely that there would be 10 5's and 10 7's and no other 6's).

We can compensate for that problem by “spreading the credit” for each rating between the rating chosen and adjacent ratings.

For instance, in one such approach, ck for 1<=k<=7 is the count of ratings equaling i plus 75% of the count of ratings which are equal to k-1 or k+1. So in the example where the current user gives a rating of 6 and there are two later raters who supplied ratings of 5 and 7 respectively, c6 is 1.5.

Let us calculate a′ (which will be subsequently transformed into a through normalized ranking). Refer to the expression for pk in Approach 7. Let s=1, and q6=0.1. C is set to 4.25, because the distribution of ck is (0, 0, 0, 0.75, 1, 1.5, 1) (where the kth element of the vector is ck) and the sum of those values is 4.25.

Then p6=((1*0.1)+1.5)/(1+4.25)=0.3, so a′=1−0.3=0.7.

Now we will calculate e′ which will be subsequently transformed into e through normalized ranking. This is calculated with respect to the earlier ratings, and since there are none in the example, we have p6=((1*0.1)+0)/(1+0)=0.1. So e′=1-0.1=0.9.

Now we process e′ and a′ as in Approach 8 to generate R.

Approach 10—rating-first

It is possible to create embodiments of this invention replacing aspects of the above discussion with entirely different approaches. For instance, Approach 4 teaches calculations for g and w (repeated here for convenience): Let g=((1−a)+sqrt((1−a)*e))/2. This is the “goodness” of the current rating. Let w=e+a−sqrt(e*a). This is the “weight” of the current rating.

These calculations were created because they give results that are consistent with our needs. For instance, w is 0 when the rater agrees with earlier ratings and with later ones (the “No Penalty” rule), and g is such that the agreement or disagreement with earlier ratings matters less and less as the disagreement with later ratings increases.

However, other embodiments of the invention use other calculations which share the most important characteristics with those described above.

For example, some embodiments are based on looking up values in tables.

For instance, suppose it is desired to create alternative goodness and weight values, not necessarily on the unit interval. In some embodiments ratings are not normalized at all, but rather the raw values are used, and simpler techniques than described above are used to treat earlier vs. later ratings. We will now consider one such embodiment.

Assume a rating scale of 1 to 7. Let m be 3 if there are no earlier ratings than the current user's. If there are one or more earlier ratings, let m be the average of those ratings. Let q be m if there are no later ratings, and the average of the later ratings if there are.

Let x be the current user's rating. Let e=absval(x−m) and let a be absval(x−q) (where absval is the absolute value).

| e | a | g | w |
|---|---|---|---|
| 0 | 0 | 3 | 0 |
| 0 | 1 | 3 | 1 |
| 0 | 2 | 2 | 2 |
| 0 | 3 | 2 | 3 |
| 0 | 4 | 1 | 4 |
| 0 | 5 | 1 | 5 |
| 0 | 6 | 0 | 6 |
| 1 | 0 | 4 | 1 |
| 1 | 1 | 4 | 1 |
| 1 | 2 | 3 | 2 |
| 1 | 3 | 2 | 2 |
| 1 | 4 | 2 | 3 |
| 1 | 5 | 1 | 4 |
| 1 | 6 | 0 | 5 |
| 2 | 0 | 5 | 2 |
| 2 | 1 | 4 | 2 |
| 2 | 2 | 3 | 2 |
| 2 | 3 | 3 | 3 |
| 2 | 4 | 2 | 3 |
| 2 | 5 | 1 | 4 |
| 2 | 6 | 0 | 5 |
| 3 | 0 | 5 | 3 |
| 3 | 1 | 4 | 2 |
| 3 | 2 | 4 | 3 |
| 3 | 3 | 3 | 3 |
| 3 | 4 | 2 | 4 |
| 3 | 5 | 1 | 4 |
| 3 | 6 | 0 | 5 |
| 4 | 0 | 5 | 4 |
| 4 | 1 | 5 | 3 |
| 4 | 2 | 4 | 3 |
| 4 | 3 | 3 | 4 |
| 4 | 4 | 2 | 4 |
| 4 | 5 | 2 | 5 |
| 4 | 6 | 0 | 5 |
| 5 | 0 | 6 | 5 |
| 5 | 1 | 5 | 4 |
| 5 | 2 | 4 | 4 |
| 5 | 3 | 3 | 4 |
| 5 | 4 | 3 | 5 |
| 5 | 5 | 2 | 5 |
| 5 | 6 | 0 | 6 |
| 6 | 0 | 6 | 6 |
| 6 | 1 | 5 | 5 |
| 6 | 2 | 4 | 5 |
| 6 | 3 | 4 | 5 |
| 6 | 4 | 3 | 5 |
| 6 | 5 | 2 | 6 |
| 6 | 6 | 0 | 6 |

So, having e and a, we do a table lookup to retrieve g and w. Then we compute the user's reliability as follows. We loop through every one of the current user's ratings, and ignore those associated with items which have less than 3 ratings from other users (because with less than 3, we don't have enough information to have any sense of the population's real opinion).

R=3 for the current user if the number of ratings he has entered is less than 3. Otherwise, R is the weighted average of his g values for the items he has rated using each g value's associated w as its weight.

This approach is not as fine-tuned as other approaches presented in this specification but it is a simple way to get the job done. It also has the advantage that the user is rated on the same 7-point scale as items are.

Approach 11—rating-first.

There is a large collection of embodiments similar in nature to Approach 10 but not using lookup tables during actual execution. In these embodiments, commonplace techniques such as neural nets, Koza's genetic programming, etc. are used to create “black boxes” that take the real world inputs and output the desired outputs. For instance, in some embodiments tables like the one in Approach 10 are created but which contain hundreds or thousands of training cases with much more fine-grained numbers and are used to train a pair of neural nets, one for g and one for w. In embodiments using genetic programming the distance between the output of an evolved function and the desired values for g and w is used as the fitness function. In preferred embodiments function evolution is carried out separately for g and w based on the same inputs.

Approach 12—rating-first.

Other embodiments combine the g and w values for the current user differently from the examples that have been discussed so far.

In one such embodiment, geometric rather than arithmetic means are computed. In Approach 4 we had:

R=((s*G)+((g1*w1)+(g2*w2)+ . . . +(gn*wn)))/(s+w1+w2+ . . . +wn).

But we are most interested in labeling users as reliable if they are consistently reliable. The geometric mean is a better approach for doing this. It works very well in particular when g values are on the unit interval with poor performance on a particular rating being near 0, as is the case in, for example, Approach 9.

R=((G\hat{ }s)*(g\hat{ }w1)*(g2\hat{ }w2)* . . . *(gn\hat{ }wn))\hat{ }(1/(s+w1+w2+ . . . +wn)).

Approach 13—rating-first.

In the discussion for Approach 9, we calculate e′ and a′ for a user who entered rating 6, using the ratings of two other users who entered a 5 and a 7, respectively. However, assume that we have computed the reliability R of each of those other users. Then we can use the Reliability as a weight to the ratings other user's ratings. Recall that we discussed a technique where ck for 1<=k<=7 is the count of ratings equalling i plus 75% of the count of ratings which are equal to k−1 or k+1. So in the example where the current user gives a rating of 6 and there are two later raters who supplied ratings of 5 and 7 respectively, c6 is 1.5.

But now suppose that the user who supplied the 5 had R=0.3 and the user who supplied the 7 had R=0.9. Then we would have c6=(0.3*0.75)+(0.9*0.75)=0.9. Similarly, C would change to reflect the weights, because the distribution of the weighted ck values would be not be (0, 0, 0, 0.75, 1, 1.5, 1) as before, but rather (0, 0, 0, 0.225, 0.3, 0.9, 0.9). So their sum, which is C, would be 2.325.

Then p6=((1*0.1)+0.9)/(1+2.325)=0.30075, so a′=1-0.30075=0.69925.

Analogously, the calculation from Approach 9 is changed to incorporate the weights in calculating e′. Then we continue as in Approach 9 to use those values to calculate R.

Of course this is a recursive approach because each user's R is calculated from other users' R's. So the R's should be initially seeded, for instance with random values on the unit interval, and then the calculations for the entire population should be run and rerun until they converge.

Practicalities of Doing the Calculations.

Preferred embodiments do these calculations in the background at some point after each new rating comes in, usually with a delay that is in the seconds or minutes (or possibly hours) rather than days or weeks. When a rating is entered, it may affect the calculated value (which takes the form of goodness g and weight w in some embodiments described here) of all earlier ratings for the item, and thus the reliability of those raters—and in cases where the reliability of each rater is used as a weight in calculating e and a this may in turn affect still other ratings.

Persons of ordinary skill in the art of efficient software design will see ways to modify the flow of calculations for the sake of efficiency and all such modifications that are still consistent with the main rules fall under the scope of the invention.

For example, in preferred embodiments, in locations in the software where an average rating (or weighted average) is to be computed, the whole computation is not done over just because a new rating is entered for the item, or a user changes his his mind about his existing rating for the item, or a weight changes on one of the ratings. Rather, the numerator and denominator involved in calculating the average are stored persistently, and when a new rating comes in, it is added to the numerator and the weight added to the denominator and the division carried out again, rather than summing each individual number. If a weight changes, the old weighted rating is subtracted from the numerator and the weight is subtracted from the denominator and the changed rating is henceforth treated as if it were a new rating. If a rating changes the old weighted rating is subtracted from the numerator and the new one added in and the division is carried out again. Of course these calculations may include “pretend” ratings and the weights may always be 1.

Other ways of making the calculations more efficient include not doing certain calculations until it appears that a significant change is likely to emerge from such calculations. For instance, in some embodiments, nothing is recalculated when a new rating comes in unless it is the fifth new rating since the last calculations for that item were done. Similar variations will be clear to any person of ordinary skill in the art of programming.

Rank-based Normalization.

In some approaches to constructing embodiments of this invention, rank-based normalization to the (0, 1) interval is used.

Assume we have a list of numbers. We sort the list so each number is greater than or equal to the number that precedes it; the greatest number is at the front and the least one is at the end.

Now, assume there are n such numbers, and assume we are interested in the rank of the ith number (based on the first element having a rank of 0). Then the rank is (i+1)/(n+1). Note that this calculation does not include 0 or 1 as possible values. One advantage to this approach is that it eliminates the need to deal with divide-by-0 errors which might otherwise happen depending on how the number is used. And given the exclusion of 0, it is seen as complementary to similarly exclude 1.

In the case that there are numbers that occur in the list more than once, we assign them all with the average of the ranks they would have if we did no special processing to handle the dups. So, for example, if we have the list 3, 7, 4, 4, and 1, and we used the rank computation given above, before handling the dups we would have:

| | Normalized |
|---|---|
| Number | Rank |
| 1 | .1666666667 |
| 3 | .333333333 |
| 4 | .5 |
| 4 | .6666666667 |
| 7 | .8333333333 |

And after handling the dups we would have:

| | Normalized |
|---|---|
| Number | Rank |
| 1 | .1666666667 |
| 3 | .333333333 |
| 4 | 0.583333333 |
| 7 | .8333333333 |

Note that this is one way of producing a rank-based number on the (0,1) interval. Other acceptible variants include modifying the calculations so that exactly 0 and exactly 1 are valid values.

Preferred embodiments store a data structure and related access function so that this calculation does not have to be carried out very frequently. In one such embodiment the sorting of numbers is done and the results are stored in an array in RAM, and the associated normalized rank is stored with each element—that is, each element is a pair of numbers, the original number and the rank on the (0,1) interval. As long as there is no reason to think the overall distribution of numbers has changed, this ordered array remains unaltered in RAM. (Note that the array may have fewer elements than the original list of numbers due to duplicates in the original list.)

When it is desired to calculate late the normalized rank of a number, a binary search is used to find the nearest number in the table. Then the normalized rank of the nearest number is returned, or an interpolation is made between the normalized ranks of the two nearest numbers.

In other such embodiments a neural net or function generated by Koza's genetic programming technique or some other analogous technique is used to more quickly approximate the results of such a binary search.

Other Variations.

Preferred embodiments, in computing the overall community opinion of each item, weight each rating with the calculated reliability of the rater. For instance, if a simple technique such as the average rating for an item is used as the community opinion, a weighted average rating with the reliability as the weight is, in some embodiments, used instead. In others, the reliability is massaged in some way before being used as a weight.

Some embodiments integrate security-related processing. For instance, there are many techniques for determining whether a user is likely to be a legitimate user vs. a phony second ID under the control of the same person, used to manipulate the system. For instance if a user usually logs onto the system from a particular IP address and then another user logs onto the system later from the same IP address and gives the same rating as the first one on a number of items, it is very likely the same person using two different ID's in an attempt to make it appear that the first user is especially reliable.

In some embodiments, this kind of information is combined with the reliability information described in this specification. For instance it was mentioned above that certain embodiments use the reliability as a weight in computing the community opinion of an item. In preferred such embodiments, more weight is also given to a rating if security calculations indicate that the user is probably legitimate. One way to do that is to multiply the two weights (security-based and reliability-based); if either is near 0 then product will be near 0.

In one set of embodiments the technique is used as an aid to evolving text. A person on the network creates a text item on a central server which visitors to the site can see—it might be an FAQ Q/A pair for example. Another person edits it, so that there are now two different versions of the same basic text. A third person can then edit the second version (or the earlier version) resulting in three versions. The first person might edit it one of those three versions creating a fourth. In Wiki Web technology (http://c2.com/cgi/wiki?WelcomeVisitors) users can modify a text item, and the most recently-created version usually becomes the one that visitors to the site will see. There are clear advantages to a service where people can rate different versions of a text item so that the best one, which is not necessarily the last one, is the one that visitors to the site see. But it takes a lot of ratings to accomplish that. The present invention enables a service provider to reward people for rating various versions of a text item. (Remember that without measuring the reliability of ratings, they can't be efficiently rewarded because people are motivated to enter meaningless ratings rather than ratings that actually consider the merit of the rated items.)

Various embodiments of the invention carry out this text-evolution technique. Now, it is clear that the value of a text item that is an edited version of another item is likely to be influenced by the value of the “parent” item. In various approaches described in this specification we have seen how background information can be used to influence the assumptions about the value of an item when there are few ratings. A person of ordinary skill in the art of creating software using Bayesian statistics would readily see how to adapt those techniques to use the probability distribution of ratings of the parent text item as background information with respect to the child text item. In general, preferred embodiments of the evolving text aspect of this invention use the parent as all or part of the basis for guessing what a malicious rater would enter to try to enter as the “right” rating without actually examining the text. This is then used to calculate e in the context of Approach 9 and others when modified to use parent-derived background information instead of all-item-but-the-current-one-derived background information.

While text is used as an example of an evolving item, other embodiments involve other kinds of items that can be modified by many people, such as artwork, musical collages, etc.; the invention is not limited in scope to any particular kind of item that can be edited by many people such that each person's output can be rated on a computer network.

By providing a means for determining reliable raters, it is possible to provide a meaningful evaluation of items. This also diminishes the ability of malicious raters to substantially alter the results. The system makes it possible to reward good raters so that the raters who provide consistent good results have an incentive to do so. The system can advantageously reward good raters in a preferential manner. A further incentive may be drawn from the ability to provide a reward for each rating on its own merits.

Some embodiments use “passive ratings.” This is information, collected during the user's normal activities without explicit action on the part of the user, which is used by the system as a kind of rating. A major example of passive ratings are Web sites which monitor the purchases each user makes and considers those as equivalent to positive ratings of the purchased items. This information is then used to decide what items deserve to be recommended to the community, or, in collaborative filtering-based sites, to specific individuals.

The present invention may be used in such contexts to determine which individuals are skilled at identifying and buying new items early that are later found to be of interest to the community in general (because they subsequently become popular). Their choices may then be presented as “cutting edge” recommendations to the community or to specific subgroups. For instance the nearest neighbors of a prescient buyer, found by using techniques such as those discussed in U.S. Pat. No. 5,884,282, could benefit from recommendations of items he purchases over time.

Some embodiments take into account the fact that some item creators are generally more apt to create highly-rated items than others. For instance some musicians are simply more talented than others. A practitioner of ordinary skill in the art of Bayesian statistics will see how to take the techniques above for generating a prior distribution from the overall population of ratings for all items and adjust them to work with the items created by a particular item creator. And such a practitioner will know how to combine the population and individual-specific distributions into a prior that can be combined with rating data for a particular item to calculate key values like our e. Such techniques enable the creation of a more realistic guesstimate about what rating might be given by a well-informed user who wants to give a rating that agrees with the community but doesn't want to take the time to actually evaluate the item himself. All such embodiments, whether Bayesian or based in one of many other applicable methodology, fall within the scope of the invention.

Preferred embodiments create one or more combined, or resolved, or population combined or consensus ratings for items which combine the opinions of all users who rated the items or of a subset of users. For instance, some such embodiments present an average of all ratings, or preferably, a weighted average of all ratings where the weight is computed at least in part from the reliability of the rater. Many other techniques can be used to combine ratings such as calculating a Bayesian expectation based on a Dirichlet prior (this is the preferred way), using a median, using a geometric or weighted geometric mean, etc. Any reasonable approach for generating a resolved community opinion is considered equivalent with respect to scope issues for this invention. Additionally, in various embodiments, such resolved ratings need not be explicitly displayed but may be used only to determine the order of presentation of items.

1. A networked computer system accepting ratings and storing for later use a value representing the reliability of raters, wherein the reliability of raters is calculated such that:
a correspondence is established between a rater's reliability and the rater's demonstrated ability to match the eventual population consensus for each item, with predetermined exceptions, wherein a rater who is unusually good at matching population opinion is assigned a high reliability, and a rater who is unusually poor at matching population opinion is assigned a low reliability;
if a rating tends to agree with the population's opinion about the rated item, and also tends to disagree with one selected from the group consisting of a reasonable estimation of the eventual opinion of an item based only on data available to the rater at the time the rating is generated and a rating a malicious user would be likely to choose if he were trying to get credit for being an accurate rater without actually taking the time to examine the rated item and determine its worth for himself, with predetermined exceptions the rater's reliability is increased relative to other raters; and
the rater's reliability is saved for future use.

2. The networked computer system of claim 1, wherein if a rating tends to agree with the population's opinion about an item in a manner which accurately predicted a change in the eventual aggregate consensus, with predetermined exceptions the rater's assigned reliability increases relative to other raters.

3. The networked computer system of claim 1, wherein if a rater tends to disagree with later ratings, then with predetermined exceptions the effect of the rater's agreement or disagreement with earlier ratings in determining the rater's overall reliability is less than if the rater tends to agree with later ratings.

4. The networked computer system of claim 1, wherein in the case of one user entering more ratings than a second user, then with predetermined exceptions the reliability of the one user would be less than the second user if other factors indicate a similar less-than-average reliability, and greater than the second user if other factors indicating a similar greater-than-average reliability.

5. The networked computer system of claim 1, wherein, in cases where two users seem, when other factors are considered, to have similar reliability, with predetermined exceptions higher reliabilities are assigned to users who enter ratings early during a lifecycle of a rated item.

6. The networked computer system of claim 1, wherein
if a rating tends to agree with earlier ratings as well as with later ones, with predetermined exceptions negative impact on the rater's overall reliability is minimized, thereby minimizing detrimental effects of late rating on the assignment of reliability to the user.

7. The networked computer system of claim 6, wherein with predetermined exceptions if a rater tends to disagree with later ratings, then the effect of the rater's agreement or disagreement with earlier ratings in determining the rater's overall reliability is less than if the rater tends to agree with later ratings.

8. The networked computer system of claim 6, wherein in the case of one user entering more ratings than a second user, then with predetermined exceptions the reliability of the one user would be less than the second user if other factors indicate a similar less-than-average reliability, and greater than the second user if other factors indicate a similar greater-than-average reliability.

9. The networked computer system of claim 6, wherein, in cases where two users seem, when other factors are considered, to have similar reliability, with predetermined exceptions higher reliabilities are assigned to users who enter ratings earlier during the lifecycles of rated items.

10. A networked computer system accepting ratings and storing for later use a value representing the reliability of raters, wherein the reliability of raters is calculated, the system comprising:
means for determination of a user identity;
means for display of items for consideration by the user;
means for selection of a displayed item by the user for review by the user;
means for assignment of a rating to the item by the user;
means for display of resolved rating values to the user;
means for including the user's rating as a part of future resolved rating values, wherein the reliability of each user is calculated such that a correspondence is established between a user's reliability and the user's demonstrated ability to match the eventual population consensus for each item, with predetermined exceptions, wherein a user who is unusually good at matching population opinion is assigned a high reliability, and a user who is unusually poor at matching population opinion is assigned a low reliability, and if a rating tends to agree with the population's opinion about an item, and also tends to disagree with at least one selected from the group consisting of a reasonable estimation of the eventual opinion of an item based only on data available to the rater at the time the rating is generated and the rating a malicious user might choose if he were trying to get credit for being an accurate rater without actually taking the time to examine the rated item and determine its worth for himself, with predetermined exceptions the user's assigned reliability increases relative to other users.

11. The networked computer system of claim 10, further comprising:
means for accepting a user interaction with the item; and
means for permitting the user to create new items.

12. The networked computer system of claim 10, further comprising means for providing a reward system as an incentive to provide user response.

13. The networked computer system of claim 10, wherein the reliability of the ratings are applied to the resolved rating values of individual items.

14. The networked computer system of claim 10, wherein resolved rating values are applied to message content of an item under review.

15. A method of accepting ratings and storing for later use a value representing the reliability of raters, in a computer networked system, wherein the reliability of raters is calculated, the method comprising:
establishing a correspondence between a rater's reliability and the rater's demonstrated ability to match the eventual population consensus for each item, with predetermined exceptions, wherein a rater who is unusually good at matching population opinion is assigned a high reliability, and a rater who is unusually poor at matching population opinion is assigned a low reliability;
if a rating tends to agree with the population's opinion about an item in a manner which accurately predicted a change in the eventual aggregate consensus, the rater's assigned reliability increases relative to other raters; and
saving the assigned reliability for future use.

16. The method of claim 15, further comprising:
if a rating tends to agree with the population's opinion about an item, and also tends to disagree with at least one selected from the group consisting of a reasonable estimation of the eventual opinion of an item based only on data available to the rater at the time the rating is generated and a rating a malicious user would be likely to choose if he were trying to get credit for being an accurate rater without actually taking the time to examine the rated item and determine its worth for himself, with predetermined exceptions the the rater's reliability increases relative to other raters.

17. The method of claim 15, further comprising:
if a rating tends to agree with the population's opinion about an item, and also tends to disagree with a reasonable estimation of the eventual opinion of an item based only on data available to the rater at the time the rating is generated, with predetermined exceptions the rater's reliability relative to other raters is increased; and
if a rating tends to agree with earlier ratings as well as with later ones, negative impact on the rater's overall reliability is with predetermined exceptions minimized, thereby minimizing negative impact on the rater's overall reliability in order to minimize detrimental effects of late rating on the assignment of reliability to the user.

18. The method of claim 15, wherein if a rater tends to disagree with later ratings, then the effect of the rater's agreement or disagreement with earlier ratings in determining the rater's overall reliability is with predetermined exceptions less than if the rater tends to agree with later ratings.

19. The networked computer system of claim 1, wherein the ratings correspond to different versions of the same document, with the purpose of enabling a version to be chosen as the most appropriate one to show users.

20. The networked computer system of claim 1, wherein at least some ratings are active ratings.

21. The networked computer system of claim 1, wherein at least some ratings are passive ratings.

22. The networked computer system of claim 1, wherein the population is a total population.

23. The networked computer system of claim 1, wherein the population is a subgroup of a total population.

24. The networked computer system of claim 1, wherein the calculations compensate for passing time such that, if it takes an overly long time for a sufficient number of ratings to accrue to an item to reasonably perform the calculations, adjustments are made such that fewer such ratings are required to reasonably perform such calculations.

25. A networked computer system for providing an assessment of the reliability of a target rater, comprising:
means for computing a population consensus for each of a plurality of items rated by the target rater;
means for calculating a guesstimate of the rating each item of the said plurality of items deserves wherein such guesstimate depends upon information selected from the group consisting essentially of ratings that were knowable by said target rater at the time said target rater rated said item and ratings that had been entered earlier than said target rater rated said item and information a malicious user might choose to base said guesstimate on if he were trying to get credit for being an accurate rater without actually taking the time to examine said items and determine their worth for himself;
means for determining one or more values in association with each said item, useful for calculating the reliability of said target rater, based upon said population consensus and said guesstimate;
means for calculating a reliability for said target rater based upon said one
or more values associated with each said item; and
computer instructions causing said reliability to be saved for future use.

26. A networked computer system for providing an assessment of the reliability of a target rater, comprising:
(a) population consensus means for computing the degree to which the ratings of said target rater tend to correspond to overall population opinion for the rated items;
(b) guesstimated value means for computing the degree to which said ratings of said target rater correspond, with predetermined exceptions, to one selected from the group of knowable population opinion for said rated items wherein said knowable population opinion was knowable to the target rater at the time of his rating and the ratings of said rated items a malicious user might choose to enter if he were trying to get credit for being an accurate rater without actually taking the time to examine said rated items and determine their worth for himself;
(c) means for calculating a reliability measurement for said target rater in response to said population consensus means and said guesstimated value means wherein, with predetermined exceptions, said reliability measurement is greater if said target rater is good at matching said population consensus and less if said target rater is poor at matching said population consensus and is also greater if said target rater is unusually able to disagree with said guesstimated value while agreeing with said population consensus; and
(d) computer instructions causing said reliability to be saved for future use.

27. The networked computer system of claim 26, further comprising:
(e) means for calculating a reliability measurement for said target rater in response to said population consensus means and said guesstimated value means, wherein there is little or no effect on said reliability measurement in response to a particular rating if that rating tends to correspond to overall population opinion for the rated item while also corresponding to knowable population opinion for said rated item.

28. The networked computer system of claim 26, wherein at least some ratings are active ratings.

29. The networked computer system of claim 26, wherein at least some ratings are passive ratings.

30. The networked computer system of claim 26, wherein the population is a total population.

31. The networked computer system of claim 26, wherein the population is a subgroup of a total population.

32. The networked computer system of claim 27, wherein at least some ratings are active ratings.

33. The networked computer system of claim 27, wherein at least some ratings are passive ratings.

34. The networked computer system of claim 27, wherein the population is a total population.

35. The networked computer system of claim 27, wherein the population is a subgroup of a total population.
